(19) United States
(12) Patent Application Publication
(10) Pub. No.: US 2006/0051609 A1
(43) Pub. Date: Mar. 9, 2006

(54) Method and structure for arresting/preventing fires in titanium clad compositions

(76) Inventors: John G. Banker, Boulder, CO (US); James A. McMaster, Huletts Landing, NY (US)

Correspondence Address: HANES & SCHUTZ, LLC, 102 SOUTH TEJON ST., SUITE 800, COLORADO SPRINGS, CO, 80903, US

(21) Appl. No.: 10/934,988

(22) Filed: Sep. 7, 2004

(51) Int. Cl. B32B 15/01; B32B 15/00

(52) U.S. Cl. 428/617; 428/618; 428/651; 428/660; 428/668; 428/670; 428/681

(57) ABSTRACT

A composite clad structure and method of producing same that is resistant to both chemical corrosion and ignition, including a metal base with an attached reactive metal component, such as titanium or zirconium, that resists initial ignition and has improved ability to arrest burning of the reactive metal, once started. The composite structure comprises a structural base layer such as carbon, low alloy, or stainless steel, an intermediate layer of high thermal conductivity metal such as copper, aluminum, silver and their alloys clad to the structural base layer and a corrosion resistant layer of reactive metal selected from the group consisting of titanium, zirconium and their alloys that is clad to the intermediate layer.

### FIELD OF THE INVENTION

The present invention relates to a multi-layered clad metal composite article of manufacture that resists chemical corrosion, ignition and propagation of fire.

### BACKGROUND OF THE INVENTION

Construction of industrial facilities that utilize processes involving chemicals and high pressure, such as autoclaves, require both structural integrity and resistance to chemical corrosion. Autoclaves for treatment of metallic ores are typically of steel construction with a corrosion resistant brick or metal lining to endure the extremely corrosive environment. Reactive metals such as titanium and zirconium and their alloys are among the very few metals suitable for lining such a structure. In the presence of high partial pressure oxygen within the autoclave, these reactive liner metals are susceptible to ignition and continued burning when their surface oxide is removed and rapid re-oxidation occurs. Removal of surface oxide can result from the breakage of a mechanical component or unintentional contact between parts. Loss of surface oxide can also result from abrasion or wear. Once started, such fires may propagate by utilizing oxygen from the surrounding air or water to sustain the reaction, even if the originating flow of oxygen is removed. The fear that reactive metal fires might breach the wall of a highly pressurized autoclave has limited the use of metals such as titanium for autoclave walls in oxygen enhanced environment reactors, except in laboratory scale units.

The threat of ignition and consequent burning of titanium components of a structure has been recognized in several prior patents that have advocated solutions to the problem. Most of the resolutions involve a coating that covers the titanium and that is expected to convey away the heat that will produce ignition of the titanium. For example, U.S. Pat. No. 4,642,027 discloses a heat conducting layer deposited as a flame or plasma sprayed metal coating to the titanium portions of a jet engine compressor section. Similarly, U.S. Pat. Nos. 4,935,193 and 5,006,419 respectively disclose a titanium alloy component provided with a titanium fire inhibiting protective coating of aluminum/niobium alloy and aluminum alone. U.S. Pat. No. 5,114,797 seeks improvement over the previously listed disclosures by providing a three-layered fire inhibiting coating over a titanium base consisting of a bond enhancing metallic base layer, a heat insulating oxide intermediate layer and a metallic cover layer. U.S. Pat. No. 5,102,697 takes a similar approach to inhibiting titanium fires by providing a multi-function protective coating on structural components of titanium or titanium alloys that are exposed to temperatures exceeding 550 degrees Celsius. In each of these cases titanium is the structural member and is protected by the overlaying coating.

Inhibiting or protecting against titanium fires is not the object of the clad plates disclosed in U.S. Pat. No. 4,393,122. The patentee illustrates certain perceived problems with explosively welding a corrosion resistant metal plate to a steel plate and presents an alternative welding process that incorporates a thin copper plate and a stainless steel net interposed between the steel plate and the corrosion resistant plate to implement a seam weld between the two outer plate components of the structure.

Against this background of prior art combinations, the primary object of the present invention to provide a clad structural metal and reactive metal composite where the reactive metal, such as titanium, resists initial ignition and has improved ability to arrest burning of the reactive metal, once started, without coating the reactive metal.

Another object of the invention is to provide a clad composite article that contains an under-layer or backing that will arrest burning past the reactive metal layer in high partial pressure oxygen environments.

A still further object of the invention is to provide a clad multi-layer article having a reactive metal component and an intermediate layer of high conductivity metal that retards and arrests burning of the reactive metal.

Other and still further objects, features and advantages of the present invention will become apparent upon a reading of the following description of the inventive process and resulting product.

### SUMMARY OF THE INVENTION

The preferred form of the present invention provides a method and resulting multi-layer composite product of structural steel plate and a sheet of titanium or a titanium alloy between which is clad an interlayer of a high thermal conductivity metal such as copper, aluminum, gold, silver or their alloys. The interlayer, disposed directly beneath the corrosion resistant titanium, conducts heat away from the titanium surface to maintain a lower temperature at the titanium surface in order to resist ignition and to arrest burning if ignition should occur. The high thermal conductivity interlayer conducts heat generated at the titanium surface more effectively than lower thermal conductivity titanium or carbon steel, thus significantly improving resistance to initial ignition of the titanium. When ignition does occur on the titanium surface, the higher thermal conductivity of the interlayer diminishes the tendency for propagation of the fire.

In addition to providing the high thermal conductivity interlayer the present invention contemplates the selection of an oxidation resistant structural backing material, such as a stainless steel alloy, to arrest burning past the titanium layer, especially in high partial pressure oxygen environments such as those that exist in some autoclaves.

### DESCRIPTION OF THE DRAWINGS

FIG. 1 is a fragmentary cross sectional view of the multi-layered composite of the present invention.

### DETAILED DESCRIPTION OF PREFERRED EMBODIMENT

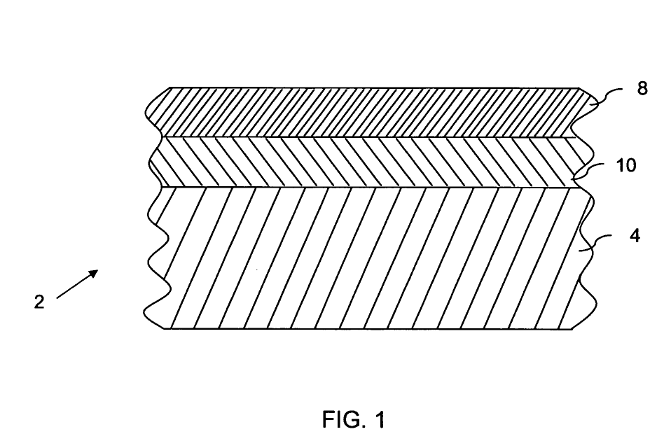

FIG. 1 illustrates in cross section the resultant composite product 2 of the present invention. The structural strength backing metal 4 is preferably a pressure vessel carbon, low alloy, or stainless steel. A high thermal conductivity sheet 10 of material, such as copper, is disposed across and clad in intimate contact with the top surface of the steel backing structure. Onto the top of the copper sheet is clad a layer 8 of reactive metal, such as titanium, zirconium or their alloys. The reactive metal layer acts as the corrosion resistant facing that lines the inside of an autoclave or similar apparatus that is constructed with the composite product 2 of the present invention.

Cladding, as used in this specification and in the claims includes all cladding technologies, such as explosive welding, roll bonding, diffusion bonding or any other bonding or attachment process that produces close intimate contact between surfaces, with or without metallurgical bonding. The well known process of explosive welding is preferred.

Because of its cost, availability, high thermal conductivity, and oxidation resistance, copper is the preferred metal for the interlayer. However, other metals having similar conductivity or oxidation resistance properties may also be used. This group of alternative metals includes aluminum, gold, silver and their alloys.

Dimensioning of the various layers is not critical, however the relative proportions may be important to achieve the objects of the invention and contain the costs of the product. The backing steel dimension is largely dictated by the structural requirements. The thickness of the titanium layer is driven by corrosion and erosion issues as well as cost. The interlayer of conductive material should preferably be as thick as practical to maximize its effectiveness in conducting heat from the titanium surface.

What is claimed is:

1. A method for producing a composite welded clad structure that is resistant to both chemical corrosion and ignition, comprising the steps of:
establishing a base layer comprising a structural strength metal.
cladding to said base layer an intermediate layer of a high thermal conductivity metal; and
cladding to said intermediate layer a corrosion resistant layer of material selected from the group consisting of reactive metals.

2. The method of claim 1 where at least one of the cladding steps is performed by explosive welding process.

3. The method of claim 1 where at least one of the cladding steps is performed by roll bonding process.

4. The method of claim 1 where at least one of the cladding steps is performed by the diffusion bonding process.

5. The method of claim 1 where the corrosion resistant layer of material is titanium or an alloy thereof.

6. The method of claim 1 where the intermediate layer is selected from the group of copper, aluminum, gold and their alloys.

7. A clad metal structural composite comprising,
a base layer of a structural metal,
an intermediate layer of high thermal conductivity metal clad to the structural metal layer, and
a corrosion resistant reactive metal layer clad to the intermediate layer.

8. The composite of claim 7 where the base layer is a carbon or stainless steel alloy.

9. The composite of claim 7 where the corrosion resistant reactive layer is titanium or a titanium alloy.

10. The composite of claim 9 where the titanium alloying elements are selected from the group comprising niobium, palladium and ruthenium.

11. The composite of claim 7 where the corrosion resistant layer is zirconium or a zirconium alloy.

12. The composite of claim 7 where the metal of the intermediate layer is selected from the group comprising copper, aluminum, gold, silver and their alloys.

13. A clad metal composite comprising,
a base structural layer of a steel alloy,
an intermediate layer of high thermal conductivity metal clad to the steel structural layer and selected from the group comprising copper, aluminum, gold, silver and their alloys, and
a corrosion resistant layer of a reactive metal clad to the intermediate layer.

14. The composite article of claim 13 where the corrosion resistant layer is titanium or a titanium alloy.

15. The composite article of claim 13 where the corrosion resistant layer is zirconium or a zirconium alloy.

16. The composite article of claim 13 where the structural layer is stainless steel.
